(19) United States
(12) Patent Application Publication
(10) Pub. No.: US 2022/0399700 A1
(43) Pub. Date: Dec. 15, 2022

(54) SINGLE CIRCUIT ELECTRICAL POWER DISTRIBUTION SPLITTER

(71) Applicant: Sikai Chen, Delran, NJ (US)

(72) Inventor: Sikai Chen, Delran, NJ (US)

(21) Appl. No.: 17/342,696

(22) Filed: Jun. 9, 2021

(51) Int. Cl. H02B 1/20; H01R 31/02; H01R 4/48

(52) U.S. Cl. CPC H02B 1/20; H01R 31/02; H01R 4/48

(57) ABSTRACT

A product distribution splitter has a main body circumscribed by a plurality of sidewalls with an electric input port extending from one of the sidewalls for receiving high wattage electrical power from an electrical power source and electrical power reduction means in the form of an IC electrical circle board for receiving the high wattage electrical power and outputting lower wattage electrical power. A cavity is located through another of the sidewalls, the cavity containing electrical conductive prongs which extend from the IC electrical circle board. The prongs receive the lower wattage electrical power and can output this power to a second PDS. Electrical wiring connected to the electrical circle board extends through a third sidewall and is attached to an electrical connector for transmitting the lower wattage electrical power to electrical circuitry.

### FIELD OF THE INVENTION

The present invention relates to the distribution of electrical power from a power source emitting high input wattage electrical power to low output wattage electrical power, with particular application to electric signage.

### BACKGROUND OF THE INVENTION

United States safety standards and regulations require that only Class 2 UL standard electrical power be used in the electrical signage industry. The output electrical power supply must be less than 60 watts for 12V or 96 watts for 24V for single electrical leads; that is there can be only one positive wire out and one negative wire out. If the power supply has multiple leads, each lead cannot be greater than 60 W/12V or 96 W/24V.

Thus, if 120 W of power are required for electrical signage under Class 2, there must be two leads from the power supply. A single lead for 120 W of power will be designated class 1, which is not permitted in the signage industry. Therefore, in order to ensure Class 2 compliance with US safety standards and regulations, current lighted signage techniques require excessive system components which are labor intensive to install. This generally results in a tremendous waste of time, material, and money.

Co-pending U.S. application Ser. No. 17/242,423 discloses an electrical power distribution splitter (PDS) which addresses these problems and limitations by utilizing a single PDS having multiple wiring extensions with integral electric connectors for connecting multiple lighting circuits. However, there is also the need for an alternative PDS to provide additional flexibility and versatility to electrical circuitry as needs arise.

### SUMMARY OF THE INVENTION

It is thus the object of the present invention to provide an electrical power distribution splitter (PDS) which is designed to receive high wattage electrical power, e.g. 80 W-600 W, and then to “split” that power into a single, low output wattage electrical power circuit, e.g. 60 W/12V or 96 W/24V.

The PDS of the present invention comprises a main body circumscribed by a plurality of sidewalls with an electric input port extending from one of the sidewalls for receiving high wattage electrical power from an electrical power source and electrical power reduction means in the form of an IC electrical circle board for receiving the high wattage electrical power and outputting lower wattage electrical power. A cavity is located through another of the sidewalls, the cavity containing electrical conductive prongs which extend from the IC electrical circle board. The prongs receive the lower wattage electrical power and can output this power to a second PDS. Electrical wiring connected to the electrical circle board extends through a third sidewall and is attached to an electrical connector for transmitting the lower wattage electrical power to electrical circuitry.

The result is the ability to input a single large wattage electrical power supply to a small power distribution splitter. This splitter then outputs a single, low wattage electrical power circuit to electric circuitry or one or more additional other PDS units, which each can output the low wattage power to different individual circuits. In so doing, Class 2 UL standard power can be utilized. This is especially important in the signage industry where, for example, a single large wattage power electrical supply feeding into the power distribution splitter can supply multiple smaller wattage power to different circuits in one sign.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### DESCRIPTION OF THE DRAWINGS

FIG. 1 is a perspective view of the power distribution splitter of the present invention.

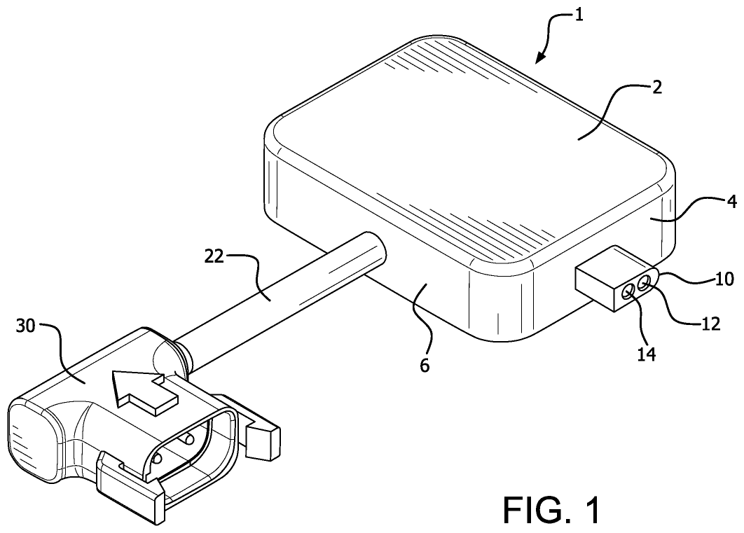

FIG. 2 is another perspective view of the power distribution splitter of the present invention.

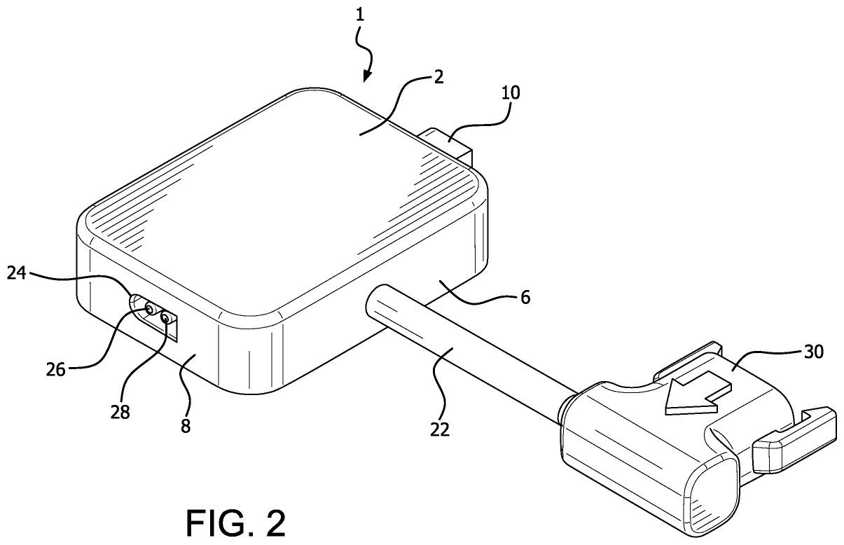

FIG. 3 shows the internal components of the power distribution splitter of the present invention.

FIG. 4 illustrates the use of multiple power distribution splitters of the present invention connected to a power source positioned to provide electrical power to multiple individual circuits.

### DETAILED DESCRIPTION OF THE INVENTION

Product distribution splitter (PDS) 1 of the present invention comprises main body 2 circumscribed by sidewalls 4, 6, and 8. Electrical input port 10 extends from sidewall 4 and has openings 12 and 14 configured to receive input electrical wiring 16 and 18 from electrical power source 100.

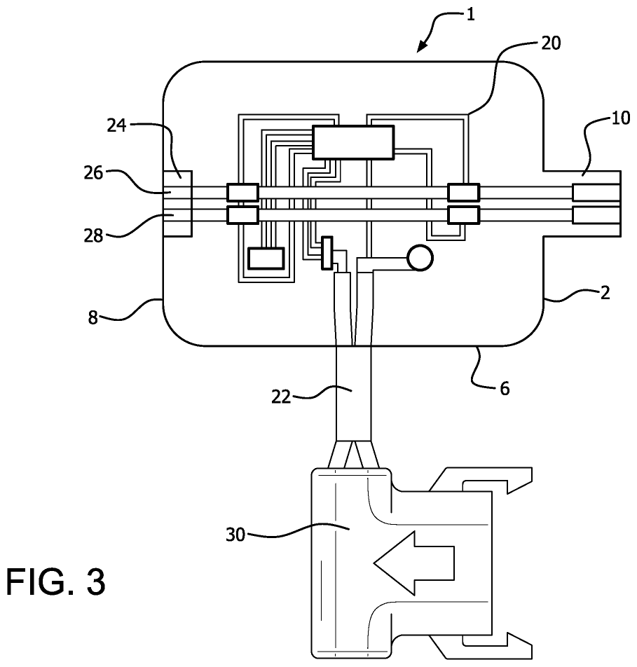

Power source 100 provides high wattage electrical power to IC electric circle board 20 located within main body 2 of PDS 1 (See FIG. 3). Circle board 20 is designed to output lower wattage electrical power. This lower electrical power is transmitted to output electrical wiring 22 extending through sidewall 6, which in turn inputs this electrical power to connector member 30. Connector member 30, an example of which is disclosed in U.S. patent application Ser. No. 16/946,601, then connects to electrical system circuitry, as disclosed in the referenced patent application as well.

The lower wattage electrical power to PDS 1 is also transmitted through main body 2 to cavity 24 in which electrical conductive prongs 26 and 28 are located. Cavity 24 opens through sidewall 8 of main body 2.

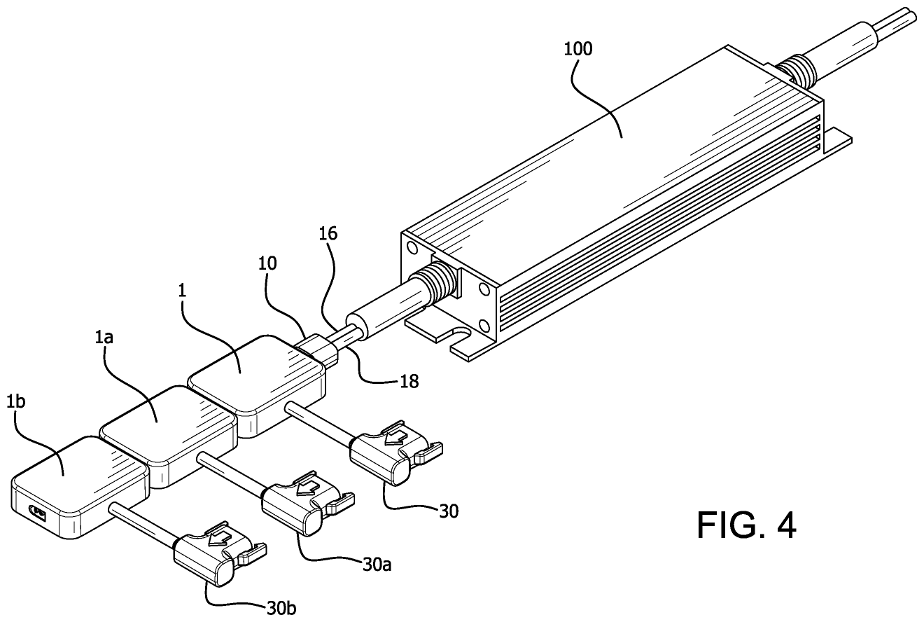

As seen in FIG. 4, a second PDS 1a identical to PDS 1, is configured so that the openings in its electrical input port can be plugged into prongs 26 and 28 of PDS 1. In this manner, lower wattage electrical power from the single power source 100 is transmitted from PDS 1 to a second PDS for connection with the electrical system circuitry through connector 30a. It is anticipated that additional PDS units, e.g. 1b etc., can be similarly connected to further increase the versatility and flexibility of providing lower wattage electrical power to multiple electrical circuits from only one high wattage electrical power source.

As an illustration, connecting PDS 1 to, for example, a 200 W/12V electrical power supply will lower the power to 60 W/12V and will allow a maximum output of 5 amps. Each PDS unit is designed to only output a maximum of 5 amps, even when multiple PDS's are hooked-up together in series. However, if one PDS is overloaded, for instance if the first one in a series receives electrical power of 72 W and 6 amps, its circle board will control and will automatically shut down, without affecting the electrical outputs of the second or third connected PDS units down the line.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An electrical power distribution splitter for delivering reduced electrical power to electrical circuitry, said power distribution splitter comprising:
a main body circumscribed by a plurality of sidewalls, said main body comprising:
an electrical input port extending from one of the plurality of sidewalls for receiving high wattage electrical power from an electrical power source;
electrical power reduction means for receiving the high wattage electrical power and for outputting lower wattage electrical power; and
a cavity opening through another of the plurality of sidewalls, said cavity having electrical conductive prongs extending from the electrical power reduction means, wherein the prongs are configured to receive the lower wattage electrical power and output said lower wattage electrical power transmitted from the power reduction means to another power distribution splitter; and
electrical wiring connected to and emanating from the power reduction means and through a third of the plurality of sidewalls, the electrical wiring extending and electrically attached to an electrical connector, wherein the lower wattage electrical power is transmitted from the power reduction means, through the electrical wiring and to the connector for transmitting the lower wattage electrical power to electrical circuitry.

2. The power distribution splitter as in claim 1 wherein the electrical power reduction means comprises an IC electric circle board.

3. The power distribution splitter as in claim 1 wherein the electrical input port comprises openings for the insertion of prongs for supplying high wattage electrical power from the electrical power source to the main body and the power reduction means.

4. The power distribution splitter as in claim 1 wherein the high wattage electrical power received by the electrical power reduction means ranges from 80 W-600 W.

5. The power distribution splitter as in claim 1 wherein the decreased low wattage electrical power ranges up to 60 W/12V and 96 W/24V.

6. The power distribution splitter as in claim 5 wherein the high wattage electrical power received by the electrical power reduction means ranges from 80 W-600 W.

7. The power distribution splitter as in claim 1 wherein the maximum amperage transmitted by the product distribution splitter is 5 amp.
